(19) United States
(12) Patent Application Publication
(10) Pub. No.: US 2008/0082371 A1
(43) Pub. Date: Apr. 3, 2008

(54) System and Method for Evaluating a Value of an Insurance Policy

(75) Inventor: Peter Phillips, Toronto (CA)

Correspondence Address: DIMOCK STRATTON LLP, 20 QUEEN STREET WEST SUITE 3202, BOX 102, TORONTO, ON, M5H 3R3, CA

(73) Assignee: Peter Phillips, Toronto (CA)

(21) Appl. No.: 11/865,314

(22) Filed: Oct. 1, 2007

(51) Int. Cl. G06Q 40/00; G06F 17/30

(52) U.S. Cl. 705/4

(57) ABSTRACT

The invention relates to a system and method for evaluating valuations groups of insurance policies. The steps involve a) retrieving at least one characteristic for each policy from the plurality of characteristics for each policy in the group of policies; b) obtaining at least one derived characteristics for each policy in the group of policies from plurality of characteristics for each policy in the group of policies; c) calculating a group expected value for each of the at least one characteristic and each of the at least one derived characteristic; d) receiving from the input device, a set of tolerances for each of the at least one characteristics and each of the at least one derived characteristic; e) minimizing a linear objective function with a set of policy weights wherein a sum of an at least one weighted characteristic, obtained by multiplying the policy weight with one each one of the at least one characteristic and each one of the at least one derived characteristic, is equal to or within the received tolerance of the group expected value for each of the one or more characteristic and each of the one or more derived characteristic; f) selecting policies with a non-zero policy weight; g) calculating at least one risk valuation result using the selected policies; and h) outputting the result of the at least one risk valuation result to the output device. The results of the at least one risk valuation result using the selected policies substantially correspond to the results of calculating the at least one risk valuation result on the group of policies.

### FIELD OF THE INVENTION

This invention relates to a system, apparatus and method for issuing insurance policies by more efficiently and cost effectively evaluating the value of financial insurance products. In particular this invention relates to efficiently determining the value of numerous financial policies.

### BACKGROUND OF THE INVENTION

Insurance contracts are used by individuals and organizations to manage risks. As people interact and make decisions, they must evaluate risks and make choices. In the face of financially severe but unlikely events, people may make decisions to act in a risk adverse manner to avoid the possibility of such outcomes. Such decisions may negatively affect business activity and the economy when beneficial but risky activities are not undertaken. With insurance, a person can shift risk and may therefore evaluate available options differently. Beneficial but risky activities may be more likely to be taken, positively benefiting business activity and the economy. The availability of insurance policies can therefore benefit those participating in the economy as well as the economy as a whole.

Insurance companies often sell financial guarantees embedded in life insurance products to customers. Generally, the focus is on selling products to people with money who want to plan for their retirement. Many of these products offer customers, the investors or policyholders, investment returns and in addition contain embedded financial guarantees. A simple product of this design is a Guaranteed Minimum Accumulation Benefit, or GMAB, where a policyholder invests money in a mutual fund or similar vehicle and is at least guaranteed to get their principal back after eight years regardless of actual fund performance. With a GMAB, the policyholder has the potential upside if markets increase over the eight years, and if the markets have fallen, the policyholder will at least get their money back.

Companies selling these financial guarantees must periodically value and report on the risk of the financial guarantees. In addition, regulatory requirements often require companies to report their risk exposure and require the companies to have sufficient reserve assets and capital on hand to support the risk profile associated with the financial guarantees they have sold. Valuing financial guarantees embedded in life insurance products for financial, risk management and regulatory reporting, is a computationally challenging prospect for insurance companies. Companies often use substantial computer power and internal and external resources to perform the necessary calculations to value and report on such products like variable annuities, segregated funds or unit linked like contracts.

There are at least several reasons why it is generally time consuming and difficult to calculate the value of such complex insurance products. Typically, these products have long maturities, with a single policy having a life span of over 30 years. In addition, the valuation of the product is path dependent, which means their value is driven not only by the final state conditions but also on the path taken to reach the final state. Further, the industry practice is to use monthly cash flows over 30 years with up to 5000 scenarios use seriatim calculations as a guiding valuation principle. Calculations on a seriatim basis means calculating the result on a policy by policy basis, in other words, the calculation is completed for every policy on a quarterly basis and perhaps more frequently in the case of multi-jurisdictional financial and regulatory reporting requirements. As an example, for a single policy, with 5000 scenarios and 360 time steps, about 1,800,000 cash flows have to be modelled, discounted and then summed back to time zero to create a net present value vector with a corresponding net present value result for each scenario.

In addition, regulatory reporting requirements may require that a conditional tail expectation be used to determine the appropriate reserves and capital requirement for the business activity.

If there is a hedge program in place, additional simulations may be required to reflect the hedging activity over each time step in each scenario. Such calculations require calculating the liability value and sensitivities, and the payoffs from the hedge portfolio at each point to create a hedging cash flow matrix with the same dimensions as the hedge item or naked liability cash flow matrix to create an overall net cash flow matrix. These nominal cash flows can then be discounted and summed back to time zero to produce a vector of net present values, of length equal to the number of scenarios used in the valuation process, which are in turn used to calculate an appropriate conditional tail expectation, under Canadian financial reporting and, with some modification, for United States regulatory reporting.

A conditional tail expectation is a sample average, or measure of central tendency on pre-selected group of ranked sample observations. CTE0 is defined as the sample average. CTE95 is defined to be the average of the worst 5% of sample observations.

The computations needed to calculate these values over all policies and over all the scenarios requires substantial time and resources. For some companies, it may take hundreds of hours using hundreds of computers to calculate the necessary quarterly financial valuations.

As described above, the calculations are performed on a seriatim basis. For each policy in the company's portfolio, each cash flow is modelled and relevant information regarding the policy is collected. For a company that has millions of policies, billions of calculations are required to produce summary valuation results. Regulators often require that the valuations be performed on every policy to ensure that sufficient capital is available and a low estimate not used. If fewer policies are used, regulators may require that companies demonstrate to the regulator that their model contains all the important risk characteristics of the whole population of policies and will not produce, intentionally or unintentionally, less conservative capital figures. It is believed that most insurance companies rely on seriatim calculations, which get more numerous as they sell more policies. Therefore, the time and resources required to calculation the valuations gets larger over time. Such constraints place effective limits on the number of policies that can be effective sold and managed in absence of additional computing resources. Companies may spend ever increasing amounts of money on these computing resources to value these products, including costs associated with internal and external resources, such as employees, consultants, hardware, redundancy and security.

These costs ultimately are built into the policy premiums and over time paid for by the policyholders, increasing the cost of the policies and making them less affordable and therefore less available to the consumer. This has a deleterious effect on risk avoidance, and thus risky activities that may be beneficial to industry and the economy are less likely to be taken, detracting from business activity and the economy.

One technique to lessen the number of required valuation calculations is called grouping. Grouping usually involves creating a list of quantitative characteristics and dividing each of these quantitative characteristic in to a series of relevant ranges, known as buckets. Each policy can then be mapped to an intersection of these ranges based on the selected quantitative characteristics to create a cell or group of similar policies. A weighing mechanism can then be used to create a ‘representative’ or pseudo policy if more than one policy if found in a cell. Such a weighing mechanism may be a midpoint, sum, or dollar weighted average. The more characteristics that are used and the more buckets that are employed in each range, the larger the number of representative policies that will be found in the final grouping.

Typically, less than 10 basic quantitative characteristics are used and typically less than 15 buckets are used for each quantitative characteristic. Using this approach, one typically ends up with about 15-30% of the original policy count in grouped policy selection process. With the grouped policies, one can then perform the seriatim valuation calculations described above on the group policies identified in the grouping process instead of on every policy.

Grouping has several disadvantages. Firstly, there is the selection of the correct set of quantitative characteristics. Selecting a poor set of quantitative characteristics may result in poor results. Secondly, the choice of the buckets can also affect the results. If the selection of buckets is done poorly, one may have cells with a no policies, whereas other cells may have thousands of policies. The choice of weighing mechanism to obtain the representative policy within each cell can also affect quality of the results. Perhaps the most significant disadvantage is the lack of certainty that the grouped selection will reproduce the quantitative characteristics of the original population, let alone time zero seriatim values or risk factor sensitivities. It is difficult to provide estimates of the accuracy of the valuation results using a grouping technique. Generally, regulators are hesitant to approve the use of such a technique without guarantees the results derived from grouping correspond to the actual results from the full population of policies.

If the amount of time and resources required to calculate the valuations is fixed, then additional policies can not be issued without adding additional resources to complete the calculations on time. In addition, if the calculations for various scenarios can be made more efficient, more scenarios can be calculated in the same amount of time resulting in more accurate valuation results for quarterly and annual reporting and for any hedging programs.

### BRIEF DESCRIPTION OF THE DRAWINGS

In drawings which illustrate by way of example only a preferred embodiment of the invention,

FIG. 1 is a schematic representation of an apparatus for implementing an embodiment of the invention.

FIG. 2 is a flow chart showing the operations performed by the apparatus of FIG. 1.

FIG. 3 is a flow chart showing a method of implementation of an embodiment of the invention.

FIGS. 4a and 4b are first and second portions of a chart containing example policy information.

FIG. 5 is a chart showing group expected values for quantitative characteristics.

FIG. 6 is a chart comparing the solution to the expected group values.

FIG. 7 is a chart containing the selected policies and corresponding policy weight coefficients.

### DETAILED DESCRIPTION OF THE INVENTION

The preferred system and method can be used to determine the valuation of a group of policies to allow issuance of further policies and to perform calculations more efficiently and at less cost than conventional techniques.

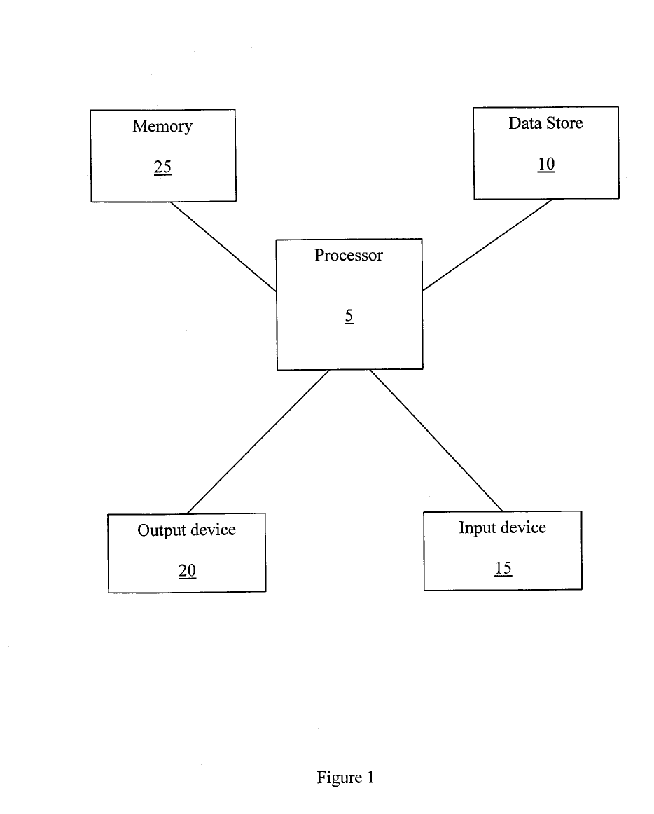

With reference to FIG. 1, a system for implementing an embodiment of the method of the invention performs a series of operations.

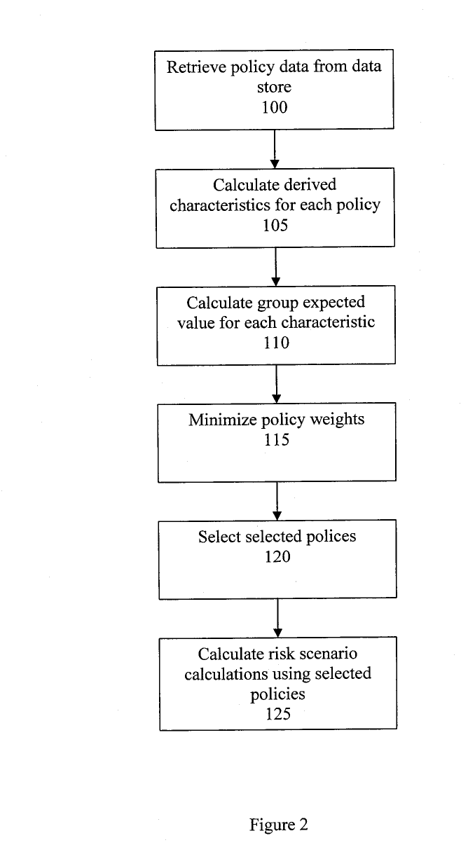

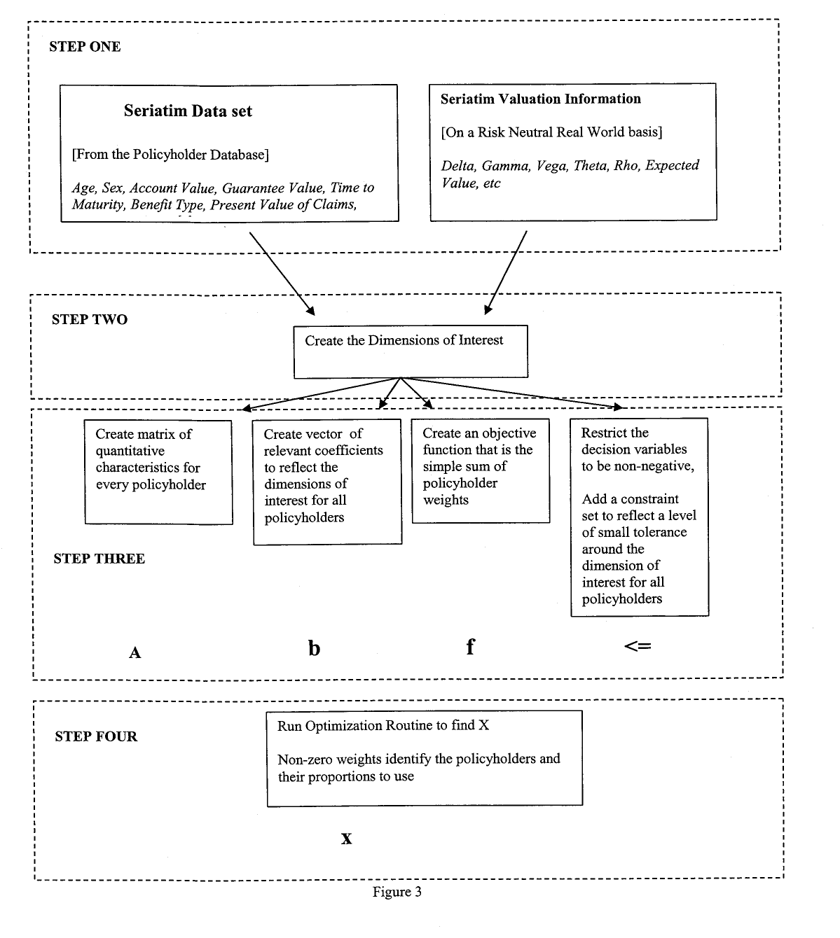

In block 100 illustrated in FIG. 2, information is obtained regarding the collection of policies of interest. Information about the policies may include value, expiry, age of a policy holder, gender of a policy holder, and/or any other information relevant to a determination of the value or intrinsic risk of policy. The database may contain a large number of policies and a large amount of information on the policies. The information in the database may optionally be transferred to the processor or memory as a first step or access to said information may be deferred until specific information is required in the later steps performed in the method.

With reference to block 105, derived data is calculated for each policy based on information extracted from each policy and from external sources of information. The derived data may be derived from a valuation model, or from perturbation or pre-selected risk scenarios. Derived data may include intermediate and final valuation calculation figures used in financial reporting or in risk management processes. Examples of the derived information are delta, vega, gamma, rho, theta, and other sensitivities of a policy to valuation model inputs. Delta, vega, gamma, rho and theta are examples of ‘The Greeks’, well known in mathematical finance and used to represent a specific measure of market based risk. For example, delta usually represents a measure of the sensitivity to changes in the price of the underlying option or policy liability and gamma is a measure of the rate of change of the delta. The derived data may also include the net present value of the policy under different scenarios or across different time steps along one or more scenarios. Each intrinsic or derived value becomes a quantitative characteristic of a policy.

The intrinsic and derived data from the policies may preferably be managed by the processor as a matrix. In the matrix, the data for each policy forms the columns. Each row of the matrix contains the data for all policies for a particular quantitative characteristic.

As indicated in block 110, an expected group value is calculated for each quantitative characteristic by adding the numeric quantity associated with each policy for a given quantitative characteristic. Each policy is given an equal weight of ‘one’ as an initial policy weight to obtain the expected group value. The expected group values are preferably managed by the processor as a vector with a length equal to the number of quantitative characteristics.

With the matrix of data for the policies and a vector of expected group values as the constraint, as indicated at block 115, the processor minimizes a linear objective function formed by combining the policy weights and policy coefficients subject to the constraints. The policy weights were fixed at ‘one’ to obtain the expected group value. If the policy weights are fixed at ‘one’ and if the policy coefficients of the objective function are also set to ‘one’, then all constraints would be satisfied, and the objective function would equal the total number of policies. To make effective use of the system, tolerances are specified for each quantitative characteristic. The tolerances may be obtained from a user using the system or from a configuration file associated with system. The tolerances set bounds on each expected group value. The minimizing policy weights, when applied to the policies, may result in group values that differ from the expected group values by the amounts specified in the tolerances.

To aid in determining the minimized policy weights, the processor may use a linear algebra optimization technique such as linear programming. The technique may be represented in the following form:
Minimize Z=c^{T}x

such that:
Ax˜b
x˜0ₙ

where
Z represents an objective function;
c represents a vector of linear coefficients for the policy coefficients, and c^{T} indicates the transpose of c;
A represents the matrix of quantitative characteristics for all the polices;
b represents a vector of expected group values;
x represents the policy weights; 0ₙ represents a vector of zeros, indicating the contraints on the system.

The minimizing policy weights determined by the processor specify the influence to be associated with each policy in the result. A number of the policy weights are likely to be zero or very close to zero, indicating that the policy associated with that coefficient is not a member of the selected policies. A policy weight which is not zero or very close to zero indicates that a policy is part of the selected policies. A group of selected policies is obtained as indicated at block 120.

As indicated in block 125, the group of selected policies and associated weights may be used by the system to calculate various values and sensitivities. Calculations performed on the selected scenarios match, within the tolerances specified, corresponding calculations performed on all the policies for all the quantitative characteristics.

Computation time and resources are reduced because the calculations need only be done on the select group of policies rather than on all the policies to obtain relevant risk and valuation results. By reducing the time and resources required to perform the calculations, an organization that issues policies can issue additional policies, improve the accuracy of current valuation statistics, and allow for risk management studies to be completed and other statistics of interest to be calculated within the same time period using the same resources.

By using tolerances, the required degree of accuracy of the scenario calculations can be balanced by the amount of calculations to be done. Generally, reducing the tolerances will result in a large group of selected policies. In addition, the results of a scenario calculation will be known to be within the specified tolerances of the result that would have been obtained by running the scenario on the all the policies.

The number of selected policies identified at block 120 is generally substantially smaller than the total number of policies and is typically about seven selected policies for every 100,000 policies. By performing scenario calculations on the selected policies, substantial time and resources can be saved or reallocated as compared to performing scenario calculations on all the policies or on the grouped policies. Less policies results in fewer computers being needed to perform the required calculations. In addition, the computing time can be used to calculate additional risk measures, help calculate the required information to support a daily hedging operation, and otherwise improve the accuracy of existing valuation statistics.

Selected policies match the initial quantitative characteristics at time zero, including the derived characteristics. In contrast, for grouping, pseudo policies will be created to match quantitative characteristics of each cell, but when combined, may not match the same seriatim statistics, or when used in the valuation process, match the reserves, capital, and sensitivity figures derived from seriatim calculations.

Using grouping, may result in absolute valuation differences greater than 5% versus seriatim valuations, as compared to typically 0.05% for valuation differences based on selected policies.

### EXAMPLE 1

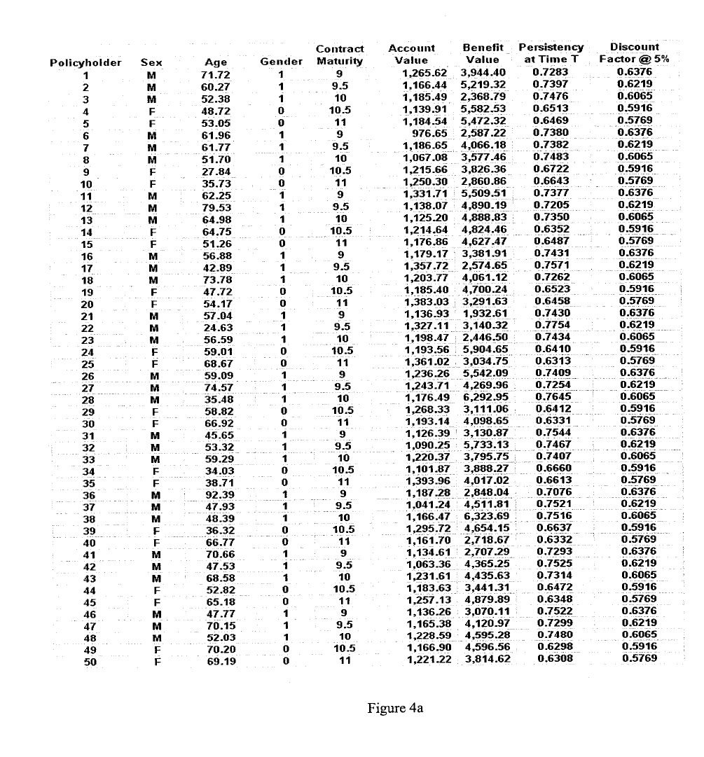

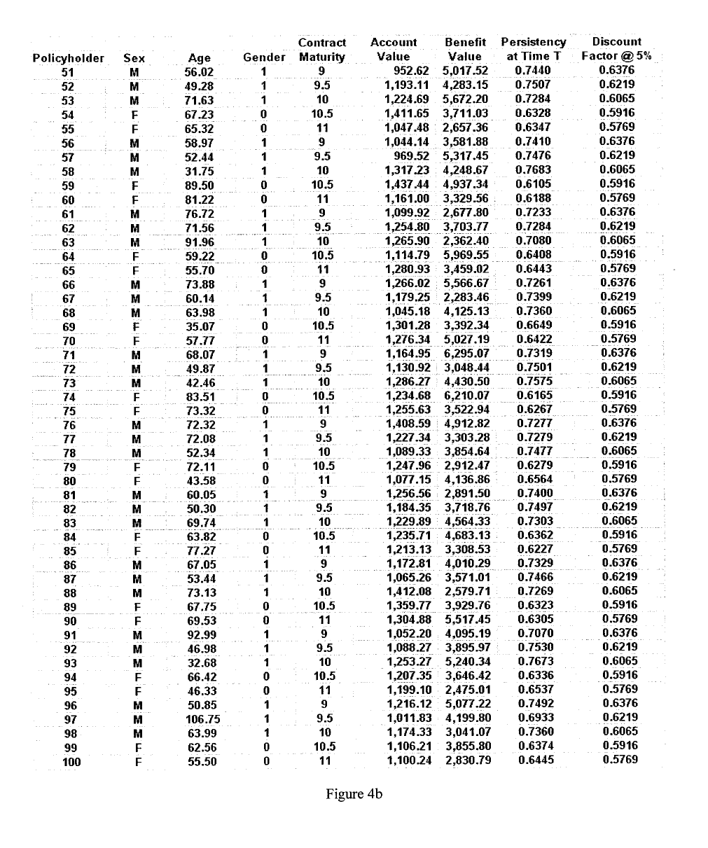

In the following example, the technique described above will be applied to a set of policies. FIGS. 4a and 4b represent 100 example policies containing both intrinsic data, such as sex, age, gender, contract maturity, account value, and benefit value, and derived data, such as persistency at Time T and discounted value. For the purposes of this example, persistency is a function of gender and age of a policyholder using the following formula:
Persistency=0.7+(gender)/10−age/1000

For the purposes of this example, the net present value of a policy for a scenario can be calculated based on the persistency, the benefit value, account value and the risk free rate.
NPV=Persistency×max(benefitBase−accountValue,0)×e^{-(riskFreeRate)T}

In this example, a number of scenarios are included and each has a different account value return ranging from 7% return in scenario 1, to −7% return in scenario 10.

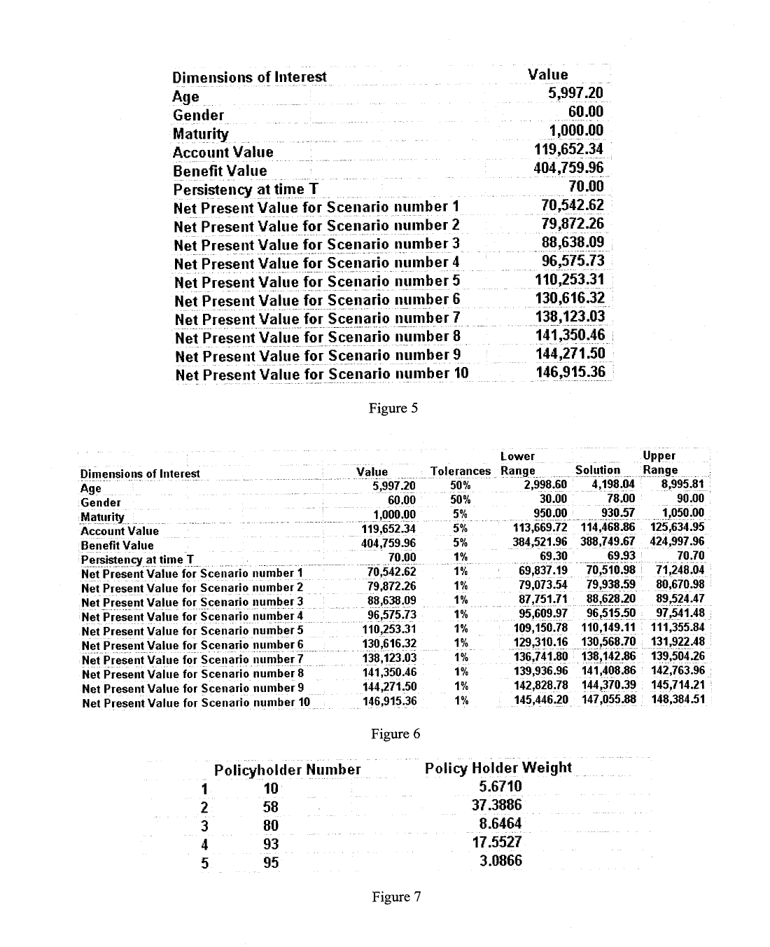

FIG. 5 indicates the expected group values for this example, including the sum of age, gender, contract maturity, account value, benefit value, persistency, and the ten scenarios across the 100 policies in our example. In this example, age, gender, contract maturity, account value, benefit value, persistency, and the ten scenarios are the quantitative characteristics.

FIG. 5 also indicates tolerances specified for each of the quantitative characteristics provided in this case by the user.

With this information, the minimization problem may be solved. As indicated in FIG. 6, the optimized result is within the provided tolerances of all the quantitative characteristics and only uses five of the policies as the final weights indicated. Although not shown, the five policies may be used in further scenario calculations to represent the characteristics of the all the policies.

System

With reference to FIG. 1, a system implementing the invention may consist of a computer processor 5 that processes and acts upon instructions contained in code. The processor 5 may consist of a single processor, a series of processors within a single computer, or a series of computers in mutual communication containing one or more processors. As used herein, a processor includes or has access to the memory 25 to perform the operations. In a preferred system, the memory 25 may consist of primary, secondary and tertiary memory.

The system further consists of a database or data store 10 containing information about one or more policies in communication with the processor 5. The processor 5 can retrieve information from the database 10.

An input device 15 in communication with the processor 5 enables the processor 5 to obtain either information from a user of the system or information created prior to the system's operation, such as a configuration file or input date file. An output device 20 is also in communication with the processor 5 and capable of displaying or storing information from the processor 5. The output device 20 may be a display device such as a computer monitor or screen, a printer, or may produce text messages, email or other electronic output.

One application for the invention is in supporting intra-day hedging activities for complex risks like variable annuities, unit linked or equity indexed annuity risks. It is difficult to calculate the relevant information to successfully manage the risks for such vehicles on an intra-day basis because of the calculation time associated with seriatim scenario based calculations and because the risks and values are sensitive to interest rate, volatility and equity market movements that occur throughout the day. Often, an overnight run is used to collect the necessary information but long run times reduce the quality and breadth of information to manage such complex risks. By selecting a small group of policies, more simulations can be completed in the available time and additional quantitative characteristics can be included to help understand and mange changing risk profiles. Typically, calculations on the selected policies take minutes to perform. With this additional information, more accurate estimates can be obtained and better risk limiting measures taken in a variable annuity hedging program.

In some regulatory environments, such as those in place in the Canadian and United States marketplaces, very substantial calculations must be performed for regulatory reporting on naked variable annuity risks. For example, the calculation of naked capital figures requires using 5000 scenarios in Canada, the use of pads or conservative parameter estimates and a conditional tail expectation with the worst 5% of all the outcomes, known as a CTE95. Regulators generally prefer seriatim calculations which would require billions of calculations to be performed in each quarter. Calculations using only selected policies significantly reduce the number of calculations that must be calculated.

A similar application can be found for the regulatory financial reporting of hedged variable annuity risks in the United States and Canada. In addition to the reporting requirements for naked variable annuity risks, reporting requirements for hedged variable annuity risks requires simulating the hedging strategy through time and include the payoffs of the hedge portfolio when calculating reserves or capital. This means that the value and sensitivity of the financial guarantees embedded in the variable annuity contracts must be found at each and every time step and path. Payoffs from the hedge portfolio must be calculated and collected along with the naked liability cash flows. This is an enormous calculational burden that generally can not be done on a seriatim basis because the valuation calculations are generally of a stochastic on stochastic nature. By using the selected policies, such calculations are more feasible and a process for selecting a small group of policies can be articulated to relevant regulators. Quantitative characteristics used for selecting relevant liability policies can include expected cash flows through time, time zero values and sensitivities, and individual value and sensitivity figures under specific market scenarios. By using only selected policies, the complex calculations can be completed at the end of each quarter on a timely basis, and important time zero and other step information can be matched and reflected in the selection process thereby producing more accurate regulatory reporting results and perhaps enhanced capital relief.

Various embodiments of the present invention having been thus described in detail by way of example, it will be apparent to those skilled in the art that variations and modifications may be made without departing from the invention.

I claim:

1. A system for evaluating risk scenarios relating to a group of insurance policies comprising
a processor in communication with a database containing a plurality of characteristics for each policy in the group of policies relating to value and risk, an input device; and
an output device;
and code implemented in the system for instructing the processor to:
a) retrieve at least one characteristic for each policy from the plurality of characteristics for each policy in the group of policies;
b) obtain at least one derived characteristic for each policy in the group of policies from the plurality of characteristics for each policy in the group of policies;
c) calculate a group expected value for each of the at least one characteristic and each of the at least one derived characteristic;
d) receive from the input device, a set of tolerances for each of the at least one characteristics and each of the at least one derived characteristic;
e) minimize a linear objective function with a set of policy weights wherein a sum of an at least one weighted characteristic, obtained by multiplying the policy weight with each one of the at least one characteristic and each one of the at least one derived characteristic, is equal to or within the received tolerance of the group expected value for each of the at least one characteristic and each of the at least one derived characteristic;
f) select policies with a non-zero policy weight;
g) calculate at least one risk valuation result using the selected policies; and
h) output the result of the at least one risk valuation result to the output device;
wherein the system outputs results of the at least one risk valuation result using the selected policies that substantially correspond to the results of calculating the at least one valuation result on the group of policies.

2. The system of claim 1 wherein the code instructs the processor to minimize a linear objective function with a set of policy weights wherein a sum of the at least one weighted characteristic, obtained by multiplying the policy weight with each one of the at least one characteristic and each one of the at least one derived characteristic, is equal to or within the received tolerance of the group expected value for each one of the at least one characteristic and each one of the at least one derived characteristic:
i) forming a matrix containing the at least one characteristic and at least one derived characteristics for all policies in the group of policies;
ii) forming a first vector containing the group expected value for each of the at least one characteristic and each of the at least one derived characteristic;
iii) forming a second vector containing policy weights for each of the policies in the group of policies;
iv) minimizing the linear objective function to obtain the policy weights such that the matrix combined with the policy weights is within the tolerances of the first vector.

3. The system of claim 1 wherein the code instructs the processor to select policies with a policy weight that is not zero or near-zero.

4. A method of efficiently calculating scenarios for a collection of policies comprising the steps of:
a) retrieving at least one characteristic for each policy from the plurality of characteristics for each policy in the group of policies;
b) obtaining at least one derived characteristics for each policy in the group of policies from the plurality of characteristics for each policy in the group of policies;
c) calculating a group expected value for each of the at least one characteristic and each of the at least one derived characteristic;
d) receiving from the input device, a set of tolerances for each of the at least one characteristics and each of the at least one derived characteristic;
e) minimizing a linear objective function with a set of policy weights wherein a sum of an at least one weighted characteristic, obtained by multiplying the policy weight with each one of the at least one characteristic and each one of the at least one derived characteristic, is equal to or within the received tolerance of the group expected value for each of the one or more characteristic and each of the one or more derived characteristic;
f) selecting policies with a non-zero policy weight;
g) calculating at least one risk valuation result using the selected policies; and
h) outputting the result of the at least one risk valuation result to the output device;
wherein the results of the at least one risk valuation result using the selected policies substantially correspond to the results of calculating the at least one risk valuation result on the group of policies.

5. The method of claim 4 wherein the step of minimizing a linear objective function with a set of policy weights wherein a sum of the at least one weighted characteristic, obtained by multiplying the policy weight with each one of the at least one characteristic and each one of the at least one derived characteristic, is equal to or within the received tolerance of the group expected value for each of the one or more characteristic and each of the one or more derived characteristic further comprises the steps of:
i) forming a matrix containing the at least one characteristic and at least one derived characteristics for all policies in the group of policies;
ii) forming a first vector containing the group expected value for each of the at least one characteristic and each of the at least one derived characteristic;
iii) forming a second vector containing policy weights for each of the policies in the group of policies;
iv) minimizing the linear objective function to obtain the policy weights such that the matrix combined with the policy weights is within the tolerances of the first vector.

6. The method of claim 4 where the selecting of policies comprises selecting policies with a policy weight that is not zero or near-zero.
